(19) United States
(12) Patent Application Publication
(10) Pub. No.: US 2019/0136032 A1
(43) Pub. Date: May 9, 2019

(54) POLY(PHENYLENE ETHER) COMPOSITION, LINED PIPE AND INJECTION MOLDED ARTICLE PREPARED THEREFROM, AND METHOD OF CONTROLLING MICROBIAL GROWTH DURING WATER TRANSPORTATION AND STORAGE

(71) Applicant: SABIC Global Technologies B.V., Bergen op Zoom (NL)

(72) Inventors: Christiaan Henricus Johannes Koevoets, Bergen op Zoom (NL); Johannes E. Fortuijn, Bergen op Zoom (NL)

(21) Appl. No.: 16/096,362

(22) PCT Filed: Mar. 3, 2017
(86) PCT No.: PCT/IB2017/051609

§ 371 Date: Oct. 25, 2018

Related U.S. Application Data
(60) Provisional application No. 62/329,348, filed on Apr. 29, 2016.

(51) Int. Cl. C08L 25/06; F16L 9/133

(52) U.S. Cl. CPC C08L 25/06; F16L 9/133; B29C 45/0001; C08L 2205/035; C08L 2203/18; C08L 2205/03

(57) ABSTRACT

A lined pipe includes an outer layer and an inner layer. The outer layer contains crosslinked polyethylene, polypropylene, poly(1-butene), or poly(vinyl chloride). The inner layer contains poly(phenylene ether), polystyrene, and, optionally, a hydrogenated block copolymer. The inner layer exhibits low stimulation of bacterial growth. Also described are a composition exhibiting low stimulation of bacterial growth, an injection molded article, and a method of controlling microbial growth during transportation or storage of water.

### BACKGROUND OF THE INVENTION

Plastic materials used to transport or store water can release components that stimulate bacterial growth. The bacteria can pose a health risk to humans and livestock that consume the water. To control bacterial growth, disinfection agents such as chlorine or chlorine dioxide are typically added to drinking water. However, in long term use, the plastic materials used to form pipes, fittings, and storage vessels can be chemically attacked by chlorine and chlorine derivatives. There is therefore a desire for pipes, fittings, and storage vessels that cause less stimulation of bacterial growth and therefore enable reduced chlorination of drinking water.

### BRIEF SUMMARY OF EMBODIMENTS OF THE INVENTION

One embodiment is a lined pipe for transporting water, comprising: an outer layer comprising an outer layer composition comprising, based on the total weight of the outer layer composition, 50 to 100 weight percent of a thermoplastic selected from the group consisting of crosslinked polyethylene, polypropylene, poly(1-butene), and poly(vinyl chloride), and 0 to 50 weight percent filler; and an inner layer comprising an inner layer composition comprising 20 to 70 parts by weight of a poly(phenylene ether), 30 to 80 parts by weight of a polystyrene, and 0 to 15 parts by weight of a hydrogenated block copolymer of an alkenyl aromatic monomer and a conjugated diene; wherein the parts by weight are based on 100 parts by weight total of the poly(phenylene ether), the polystyrene, and the hydrogenated block copolymer.

Another embodiment is an injection molded article for water contact, the article comprising a composition comprising: 30 to 50 parts by weight of a poly(2,6-dimethyl-1,4-phenylene ether) having an intrinsic viscosity of 0.1 to 0.6 deciliter per gram measured by Ubbelohde viscometer at 25° C. in chloroform; 35 to 55 parts by weight of an atactic homopolystyrene having a having a melt flow index of 1 to 5 grams per 10 minutes measured according to ISO 1133-4 (2011) at 200° C. and 5 kilogram load; and 1 to 15 parts by weight of a polystyrene-poly(ethylene-butylene)-polystyrene triblock copolymer; wherein parts by weight are based on 100 parts by weight total of the poly(phenylene ether), the polystyrene, and the hydrogenated block copolymer; wherein the composition excludes rubber-modified polystyrene, excludes unhydrogenated block copolymers of styrene and butadiene, and comprises less than 1 part per million by weight of free butadiene, based on the total weight of the inner layer composition; and wherein the composition exhibits a Biomass Production Potential less than or equal to 500 picograms adenosine triphosphate per centimeter² determined according to NEN-EN 16421:2014 method 1.

Another embodiment is a method of controlling microbial growth during transportation or storage of water, the method comprising transporting or storing the water in contact with a surface having a composition comprising 20 to 70 parts by weight of a poly(phenylene ether), 30 to 80 parts by weight of a polystyrene, and 1 to 15 parts by weight of a hydrogenated block copolymer of an alkenyl aromatic monomer and a conjugated diene; wherein the parts by weight are based on 100 parts by weight total of the poly(phenylene ether), the polystyrene, and the hydrogenated block copolymer.

Another embodiment is a composition, comprising, 30 to 50 parts by weight of a poly(2,6-dimethyl-1,4-phenylene ether) having an intrinsic viscosity of 0.1 to 0.6 deciliter per gram measured by Ubbelohde viscometer at 25° C. in chloroform; 35 to 55 parts by weight of an atactic homopolystyrene having a having a melt flow index of 1 to 5 grams per 10 minutes measured according to ISO 1133-4 (2011) at 200° C. and 5 kilogram load; and 1 to 15 parts by weight of a hydrogenated block copolymer of an alkenyl aromatic monomer and a conjugated diene; wherein parts by weight are based on 100 parts by weight total of the poly(phenylene ether), the polystyrene, and the hydrogenated block copolymer; wherein the composition excludes rubber-modified polystyrene, excludes unhydrogenated block copolymers of styrene and butadiene, and comprises less than 1 part per million by weight of free butadiene, based on the total weight of the inner layer composition; and wherein the composition exhibits a Biomass Production Potential less than or equal to 500 picograms adenosine triphosphate per centimeter² determined according to NEN-EN 16421:2014 method 1.

These and other embodiments are described in detail below.

### BRIEF DESCRIPTION OF THE DRAWINGS

Referring now to the drawings wherein like elements are numbered alike in several FIGURES.

FIG. 1 is a cross-sectional view of a lined pipe 10 comprising an outer layer 20 and an inner layer 30.

FIG. 2 is a cross-sectional view of a lined pipe 10 comprising an outer layer 20, an inner layer 30, and an intermediate layer 40.

FIG. 3 is a cross-sectional view of a lined pipe 10 comprising an outer layer 20, an inner layer 30, and two intermediate layers 40.

FIGS. 4A-4C show atomic force micrographs for as-extruded surfaces of high density polyethylene (4A), a poly(phenylene ether) composition (4B), and unplasticized poly(vinyl chloride) (4C).

### DETAILED DESCRIPTION OF THE INVENTION

The present inventors have determined that particular poly(phenylene ether) compositions exhibit very low stimulation of bacterial growth. The compositions can be employed as an inner lining on pipes, as an injection molded article for water contact, and in general as surfaces for contact with drinking water.

Thus, one embodiment is a lined pipe for transporting water, comprising: an outer layer comprising an outer layer composition comprising, based on the total weight of the outer layer composition, 50 to 100 weight percent of a thermoplastic selected from the group consisting of crosslinked polyethylene, polypropylene, poly(1-butene), and poly(vinyl chloride), and 0 to 50 weight percent filler; and an inner layer comprising an inner layer composition comprising 20 to 70 parts by weight of a poly(phenylene ether), 30 to 80 parts by weight of a polystyrene, and 0 to 15 parts by weight of a hydrogenated block copolymer of an alkenyl aromatic monomer and a conjugated diene; wherein the parts by weight are based on 100 parts by weight total of the poly(phenylene ether), the polystyrene, and the hydrogenated block copolymer.

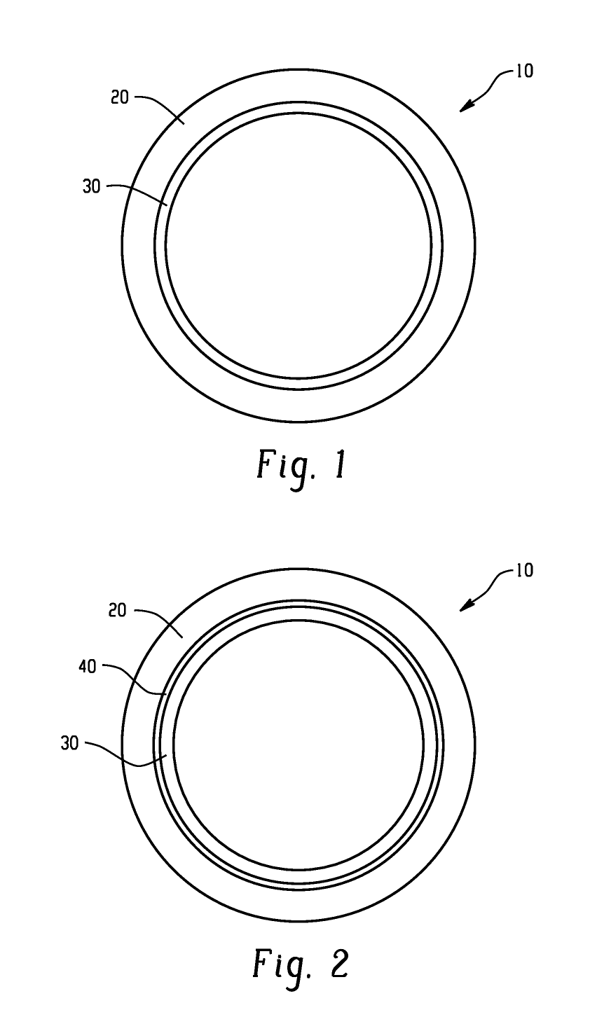

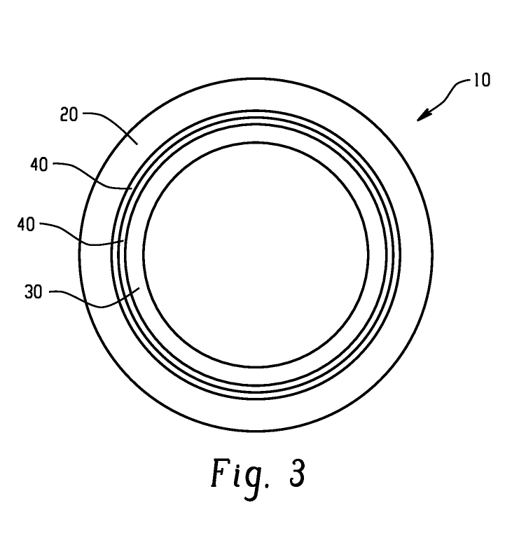

One embodiment relates to a lined pipe. One embodiment, illustrated in FIG. 1, is a pipe 10 comprising an outer layer 20 and an inner layer 30. Another embodiment, illustrated in FIG. 2, is a pipe 10 comprising an outer layer 20, an inner layer 30, and an intermediate layer 40 between the outer layer 20 and the inner layer 30. Another embodiment, illustrated in FIG. 3, is a pipe 10 comprising an outer layer 20, an inner layer 30, and two intermediate layers 40, each between the outer layer 20 and the inner layer 30. When there are two or more intermediate layers, they can have compositions that are the same as or different from each other. The compositions of the various layers are described in detail below.

The lined pipe can vary widely in size. For example, in some embodiments the outer layer has an outer diameter of 20 millimeters to 1.6 meters and a ratio of outer diameter to wall thickness of 7:1 to 45:1. In these embodiments, the inner layer can, optionally, have an outer diameter of 12 millimeters to 1.55 meters and/or a wall thickness of 50 micrometers to one-third the wall thickness of the outer layer.

The lined pipe includes an outer layer based on a thermoplastic selected from the group consisting of crosslinked polyethylene, polypropylene, poly(1-butene), and poly(vinyl chloride). In some embodiments, the thermoplastic is selected from the group consisting of crosslinked polyethylene, polypropylene, poly(1-butene), and poly(vinyl chloride). In some embodiments, the thermoplastic is polypropylene (i.e., propylene homopolymer). The composition of the outer layer comprises 50 to 100 weight percent of the thermoplastic, based on the total weight of the outer layer composition. Within this range, the thermoplastic content can be 70 to 100 weight percent, or 80 to 100 weight percent, or 90 to 100 weight percent, or 95 to 100 weight percent. Other than the thermoplastic, the outer layer composition can, optionally, include up to 50 weight percent of fillers. Suitable fillers include talc, clay, mica, calcium carbonate, and combinations thereof. Within the range of 0 to 50 weight percent, the filler amount can be 5 to 50 weight percent, or 5 to 40 weight percent, or 5 to 30 weight percent. The outer layer composition can, optionally, further include up to 10 weight percent of additives selected from the group consisting of colorants, UV blockers, antioxidants, stabilizers, processing aids, and combinations thereof. Within the limit of 10 weight percent, the additive amount can be 0 to 5 weight percent, or 0 to 2 weight percent.

In addition to the outer layer, the lined pipe or fitting includes an inner layer exhibiting low stimulation of bacterial growth. The composition of the inner layer comprises a poly(phenylene ether). The poly(phenylene ether) comprises repeat units of the formula

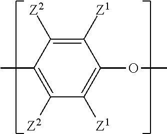

wherein each occurrence of Z¹ is independently C₁-C₁₂ hydrocarbylthio, C₁-C₁₂ hydrocarbyloxy, or unsubstituted or substituted C₁-C₁₂ hydrocarbyl provided that the hydrocarbyl group is not tertiary hydrocarbyl; and each occurrence of Z² is independently hydrogen, C₁-C₁₂ hydrocarbylthio, C₁-C₁₂ hydrocarbyloxy, or unsubstituted or substituted C₁-C₁₂ hydrocarbyl provided that the hydrocarbyl group is not tertiary hydrocarbyl. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. When the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

The poly(phenylene ether) can comprise molecules having aminoalkyl-containing end group(s), typically located in a position ortho to the hydroxyl group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

In some embodiments, the poly(phenylene ether) has an intrinsic viscosity of 0.1 to 1 deciliter per gram measured by Ubbelohde viscometer at 25° C. in chloroform. Within this range, the poly(phenylene ether) intrinsic viscosity can be 0.1 to 0.6 deciliter per gram, 0.2 to 0.6 deciliter per gram, or 0.25 to 0.55 deciliter per gram.

In some embodiments, the poly(phenylene ether) comprises a homopolymer or copolymer of monomers selected from the group consisting of 2,6-dimethylphenol, 2,3,6-trimethylphenol, and combinations thereof. In some embodiments, the poly(phenylene ether) comprises a poly(2,6-dimethyl-1,4-phenylene ether) having an intrinsic viscosity of 0.1 to 0.6 deciliter per gram, measured at 25° C. in chloroform.

The inner layer composition comprises 20 to 70 parts by weight of the poly(phenylene ether), based on 100 parts by weight total of the poly(phenylene ether), the polystyrene, and the hydrogenated block copolymer. Within the range of 20 to 70 parts by weight, the poly(phenylene ether) amount can be 30 to 60 parts by weight, or 30 to 50 parts by weight.

In addition to the poly(phenylene ether), the inner layer composition comprises polystyrene. As used herein, the term polystyrene means a homopolymer of styrene. The polystyrene can be atactic, syndiotactic, or isotactic, or a combination thereof. In some embodiments, the polystyrene comprises atactic homopolystyrene. In some embodiments, the polystyrene comprises an atactic homopolystyrene having a having a melt flow index of 1 to 5 grams per 10 minutes, or 1.5 to 5 grams per 10 minutes, or 1.5 to 3.5 grams per 10 minutes, or 1.9 to 2.9 grams per 10 minutes, measured according to ISO 1133-4 (2011) at 200° C. and 5 kilogram load. In some embodiments, the polystyrene excludes syndiotactic homopolystyrene.

The inner layer composition comprises 30 to 80 parts by weight of the polystyrene, based on 100 parts by weight total of the poly(phenylene ether), the polystyrene, and the hydrogenated block copolymer. Within the range of 30 to 80 parts by weight, the polystyrene amount can be 40 to 70 parts by weight, or 40 to 60 parts by weight.

In some embodiments, the inner layer composition comprises a hydrogenated block copolymer of an alkenyl aromatic monomer and a conjugated diene. For brevity, this component is referred to as the “hydrogenated block copolymer”. The hydrogenated block copolymer can comprise 10 to 90 weight percent of poly(alkenyl aromatic) content and 90 to 10 weight percent of hydrogenated poly(conjugated diene) content, based on the weight of the hydrogenated block copolymer. In some embodiments, the hydrogenated block copolymer is a low poly(alkenyl aromatic content) hydrogenated block copolymer in which the poly(alkenyl aromatic) content is 10 to less than 40 weight percent, or 20 to 35 weight percent, or 25 to 35 weight percent, all based on the weight of the low poly(alkenyl aromatic content) hydrogenated block copolymer. In other embodiments, the hydrogenated block copolymer is a high poly(alkenyl aromatic) content hydrogenated block copolymer in which the poly(alkenyl aromatic) content is 40 to 90 weight percent, or 50 to 80 weight percent, or 60 to 70 weight percent, all based on the weight of the high poly(alkenyl aromatic content) hydrogenated block copolymer.

In some embodiments, the hydrogenated block copolymer has a weight average molecular weight of 40,000 to 400,000 atomic mass units. The number average molecular weight and the weight average molecular weight can be determined by gel permeation chromatography and based on comparison to polystyrene standards. In some embodiments, the hydrogenated block copolymer has a weight average molecular weight of 200,000 to 400,000 atomic mass units.

The alkenyl aromatic monomer used to prepare the hydrogenated block copolymer can have the structure

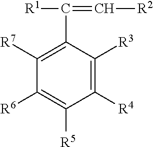

wherein R¹ and R² each independently represent a hydrogen atom, a C₁-C₈ alkyl group, or a C₂-C₈ alkenyl group; R³ and R⁷ each independently represent a hydrogen atom or a C₁-C₈ alkyl group; and R⁴, R⁵, and R⁶ each independently represent a hydrogen atom, a C₁-C₈ alkyl group, or a C₂-C₈ alkenyl group, or R⁴ and R⁵ are taken together with the central aromatic ring to form a naphthyl group, or R⁵ and R⁶ are taken together with the central aromatic ring to form a naphthyl group. Specific alkenyl aromatic monomers include, for example, styrene, methylstyrenes such as alpha-methylstyrene and p-methylstyrene, and t-butylstyrenes such as 3-t-butylstyrene and 4-t-butylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and combinations thereof. In some embodiments, the conjugated diene is 1,3-butadiene, 2-methyl-1,3-butadiene, or a combination thereof. In some embodiments, the conjugated diene is 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, or at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In some embodiments, the hydrogenated block copolymer is a diblock copolymer, a triblock copolymer, or a combination thereof.

In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In other embodiments, the hydrogenated block copolymer includes the residue of one or more acid functionalizing agents, such as maleic anhydride.

In some embodiments, the hydrogenated block copolymer comprises a polystyrene-poly(ethylene-butylene)-polystyrene triblock copolymer having a weight average molecular weight of 200,000 to 400,000 grams/mole.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Performance Polymers Inc. as KRATON™ G1701 (having about 37 weight percent polystyrene) and G1702 (having about 28 weight percent polystyrene); the polystyrene-poly(ethylene-butylene)-polystyrene triblock copolymers available from Kraton Performance Polymers Inc. as KRATON™ G1641 (having about 33 weight percent polystyrene), G1650 (having about 30 weight percent polystyrene), G1651 (having about 33 weight percent polystyrene), and G1654 (having about 31 weight percent polystyrene); and the polystyrene-poly(ethylene-ethylene/propylene)-polystyrene triblock copolymers available from Kuraray as SEPTON™ S4044, S4055, S4077, and S4099. Additional commercially available hydrogenated block copolymers include polystyrene-poly(ethylene-butylene)-polystyrene (SEBS) triblock copolymers available from Dynasol as CALPRENE™ H6140 (having about 31 weight percent polystyrene), H6170 (having about 33 weight percent polystyrene), H6171 (having about 33 weight percent polystyrene), and H6174 (having about 33 weight percent polystyrene); and from Kuraray as SEPTON™ 8006 (having about 33 weight percent polystyrene) and 8007 (having about 30 weight percent polystyrene); polystyrene-poly(ethylene-propylene)-polystyrene (SEPS) copolymers available from Kuraray as SEPTON™ 2006 (having about 35 weight percent polystyrene) and 2007 (having about 30 weight percent polystyrene); and oil-extended compounds of these hydrogenated block copolymers available from Kraton Performance Polymers Inc. as KRATON™ G4609 (containing about 45% mineral oil, and the SEBS having about 33 weight percent polystyrene) and G4610 (containing about 31% mineral oil, and the SEBS having about 33 weight percent polystyrene); and from Asahi as TUFTEC™ H1272 (containing about 36% oil, and the SEBS having about 35 weight percent polystyrene). Mixtures of two of more hydrogenated block copolymers can be used.

In some embodiments, the hydrogenated block copolymer is a food grade hydrogenated block copolymer. In the US, substances used in food contact articles are defined and regulated according to 31 CFR 170.39. Under the European Food Safety Authority, general requirements for all food contact materials are defined in Framework Regulation EC 1935/2004; Good Manufacturing Practice for materials and articles intended to come in contact with food is described in Regulation EC 2023/2006. Food grade hydrogenated block copolymers include KRATON™ G1650, G1651, G1652, G1654, and G1657, which are all polystyrene-poly(ethylene-butylene)-polystyrene triblock copolymers available from Kraton Performance Polymers Inc.

When present in the inner layer composition, the hydrogenated block copolymer can be used in an amount of 1 to 15 parts by weight, based on 100 parts by weight total of the poly(phenylene ether), the polystyrene, and the hydrogenated block copolymer. Within this range, the hydrogenated block copolymer amount can be 2 to 15 parts by weight, or 5 to 15 parts by weight, or 8 to 14 parts by weight.

In some embodiments, the inner layer composition comprises less than 1 part per million by weight of free butadiene, based on the total weight of the inner layer composition. The presence of free (unpolymerized) butadiene is generally associated with the presence of unhydrogenated polymers and copolymers comprising polybutadiene. For example, including in the inner layer composition a polybutadiene-containing rubber-modified polystyrene can make it difficult to achieve a free butadiene concentration less than 1 part per million. The term “rubber-modified polystyrene” as used herein refers to the product of combining styrene-butadiene random copolymer and/or polybutadiene with polystyrene, either during or after polymerization of the polystyrene, such that the finished basic polymers contains not less than 80 weight percent of total polymer units derived from styrene monomer. Rubber-modified polystyrene is distinct from styrene-butadiene block copolymers. In some embodiments, the inner layer composition excludes rubber-modified polystyrene. It should be noted that it is possible to achieve a free butadiene content less than 1 part per million while still including in the inner layer composition hydrogenated polymers and copolymers in which polybutadiene has been hydrogenated.

The inner layer composition can, optionally, further comprise one or more additives known in the thermoplastics art. For example, the inner layer composition can, optionally, further comprise an additive selected from the group consisting of stabilizers, mold release agents, lubricants, processing aids, UV blockers, dyes, pigments, antioxidants, anti-static agents, mineral oil, metal deactivators, and combinations thereof. When present, such additives are typically used in a total amount of less than or equal to 10 parts by weight, or less than or equal to 5 parts by weight, or less than or equal to 2 parts by weight, based on 100 parts by weight total of the poly(phenylene ether), the polystyrene, and the hydrogenated block copolymer.

The outer layer composition and the inner layer composition can, optionally, minimize or exclude components not described herein as required or optional. In some embodiments, the outer layer composition and the inner layer composition exclude flame retardants (including organophosphate esters, metal dialkylphosphinates, bis(phenoxy)phosphazenes, melamine phosphates, melamine pyrophosphates, melamine polyphosphates, melamine cyanurates, metal hydroxides, and combinations thereof). In some embodiments, the inner layer composition comprises 0 to 2 parts by weight of (or excludes) rubber-modified polystyrenes. In some embodiments, the inner layer composition comprises 0 to 2 parts by weight of (or excludes) polyamides. In some embodiments, the inner layer composition comprises 0 to 2 parts by weight of (or excludes) of polyolefins. In some embodiments, the inner layer composition comprises 0 to 2 parts by weight of low density polyethylene and otherwise excludes polyolefins. All parts by weight are based on 100 parts by weight total of the poly(phenylene ether), the polystyrene, and the hydrogenated block copolymer.

One advantage of the inner layer is that its inner (exposed) surface can be relatively smooth. This can be quantified using the surface roughness parameters Rₐ and R_{q}. For example, in some embodiments, the inner layer comprises an inner surface having a roughness average, Rₐ, value of 3 to 15 nanometers, and a root mean square roughness, R_{q}, value of 7 to 25 nanometers. With the range of 3 to 15 nanometers, Rₐ can have a value of 5 to 10 nanometers. With the range of 7 to 25 nanometers, R_{q} can have a value of 10 to 20 nanometers. Methods of measuring surface roughness and calculating Rₐ and R_{q} parameters are known in the art. For example, as demonstrated in the working examples below, measurements can be performed using atomic force microscopy (AFM). Calculation of Rₐ and R_{q} values is described in T. V. Vorburger and J. Raja, “Surface Finish Metrology Tutorial”, NISTIR 89-4088, June 1990, page 36, FIG. 3-22.

In addition to the outer layer and the inner layer, the lined pipe can, optionally, include at least one intermediate layer disposed between the outer layer and the inner layer. In some embodiments, the lined pipe or fitting comprises two intermediate layers. In other embodiments, the lined pipe or fitting comprises three intermediate layers. The one or more intermediate layers can each independently comprise a material selected from the group consisting of aromatic epoxy resins, acid-functionalized polyolefins (including maleic anhydride-functionalized high density polyethylene), acid-functionalized poly(phenylene ether)s (including maleic anhydride-functionalized poly(phenylene ether)s), styrene-maleic anhydride copolymers, and combinations thereof.

In a very specific embodiment of the lined pipe, the outer layer composition comprises 95 to 100 weight percent polypropylene; the poly(phenylene ether) comprises a poly(2,6-dimethyl-1,4-phenylene ether) having an intrinsic viscosity of 0.1 to 0.6 deciliter per gram, measured at 25° C. in chloroform; the polystyrene comprises an atactic homopolystyrene having a melt flow index of 1.5 to 3.5 grams per 10 minutes measured according to ISO 1133-4 (2011) at 200° C. and 5 kilogram load; the inner layer composition comprises 1 to 15 parts by weight of the hydrogenated block copolymer; and wherein the hydrogenated block copolymer is a polystyrene-poly(ethylene-butylene)-polystyrene triblock copolymer having a polystyrene content of about 25 to 40 weight percent and a weight average molecular weight of about 200,000 to 400,000 grams/mole; and the inner layer composition comprises 35 to 45 parts by weight of the poly(phenylene ether), 43 to 53 parts by weight of the polystyrene, and 5 to 15 parts by weight of the hydrogenated block copolymer. In this embodiment, the inner layer composition can, optionally, comprise less than 1 part per million by weight of free butadiene. Also in this embodiment, the inner layer composition can, optionally, exclude rubber-modified polystyrene.

The lined pipe can be formed by coextrusion of the outer layer, the inner layer, and any intermediate layers. One embodiment is a method of forming a lined pipe or fitting, comprising: coextruding an outer layer and an inner layer; wherein the outer layer is annular in cross-section and characterized by a first outer diameter, a first inner diameter and a first wall thickness; wherein the outer layer comprises an outer layer composition comprising, based on the total weight of the outer layer composition, 50 to 100 weight percent of a thermoplastic selected from the group consisting of crosslinked polyethylene, polypropylene, poly(1-butene), and poly(vinyl chloride), and 0 to 50 weight percent filler; wherein the inner layer is annular in cross-section and characterized by a second outer diameter less than the first inner diameter, a second inner diameter, and a second wall thickness; wherein the inner layer comprises an inner layer composition comprising 20 to 70 parts by weight of a poly(phenylene ether), 30 to 80 parts by weight of a polystyrene, and 0 to 15 parts by weight of a hydrogenated block copolymer of an alkenyl aromatic monomer and a conjugated diene; wherein the parts by weight are based on 100 parts by weight total of the poly(phenylene ether), the polystyrene, and the hydrogenated block copolymer.

In some embodiments of the lined pipe, it consists of the outer layer and the inner layer, and the second outer diameter (i.e., the outer diameter of the inner layer) is 98 to less than 100 percent of the first inner diameter (i.e., the inner diameter of the outer layer), or 99 to less than 100 percent of the first inner diameter.

In other embodiments, the method further comprises coextruding with the outer layer and the inner layer at least one intermediate layer, annular in cross-section and characterized by a third outer diameter less than the first inner diameter and a third inner diameter greater than the second outer diameter.

In a very specific embodiment of the method of forming a lined pipe, the outer layer composition comprises 95 to 100 weight percent polypropylene; the poly(phenylene ether) comprises a poly(2,6-dimethyl-1,4-phenylene ether) having an intrinsic viscosity of 0.1 to 0.6 deciliter per gram, or 0.3 to 0.6 deciliter per gram, measured at 25° C. in chloroform; the polystyrene comprises an atactic homopolystyrene having a melt flow index of 1.5 to 3.5 grams per 10 minutes measured according to ISO 1133-4 (2011) at 200° C. and 5 kilogram load; the hydrogenated block copolymer comprises a polystyrene-poly(ethylene-butylene)-polystyrene triblock copolymer having a weight average molecular weight of 200,000 to 400,000 grams/mole; and the inner layer composition comprises 35 to 45 parts by weight of the poly(phenylene ether), 43 to 53 parts by weight of the polystyrene, and 5 to 15 parts by weight of the hydrogenated block copolymer. In this embodiment, the inner layer composition can, optionally, comprise less than 1 part per million by weight of free butadiene. Also in this embodiment, the inner layer composition can, optionally, exclude rubber-modified polystyrene.

Another embodiment is a an injection molded article for water contact, the article comprising a composition comprising: 30 to 50 parts by weight of a poly(2,6-dimethyl-1,4-phenylene ether) having an intrinsic viscosity of 0.1 to 0.6 deciliter per gram measured by Ubbelohde viscometer at 25° C. in chloroform; 35 to 55 parts by weight of an atactic homopolystyrene having a melt flow index of 1 to 5 grams per 10 minutes measured according to ISO 1133-4 (2011) at 200° C. and 5 kilogram load; and 1 to 15 parts by weight of a polystyrene-poly(ethylene-butylene)-polystyrene triblock copolymer; wherein parts by weight are based on 100 parts by weight total of the poly(phenylene ether), the polystyrene, and the hydrogenated block copolymer; wherein the composition excludes rubber-modified polystyrene, excludes unhydrogenated block copolymers of styrene and butadiene, and comprises less than 1 part per million by weight of free butadiene, based on the total weight of the inner layer composition; and wherein the composition exhibits a Biomass Production Potential less than or equal to 500 picograms adenosine triphosphate per centimeter² determined according to NEN-EN 16421:2014 method 1. All of the variations described above for the inner layer composition of the lined pipe apply as well to the composition used to form the injection molded article. In some embodiments, the poly(2,6-dimethyl-1,4-phenylene ether) has a weight average molecular weight of 25,000 to 60,000 grams/mole. In some embodiments, the injection molded article comprises a surface (e.g., a water-contacting surface) characterized by surface roughness parameters Rₐ having a value of 3 to 15 nanometers, and R_{q} having a value of 7 to 25 nanometers.

The composition used to form the injection molded article can, optionally, include glass fibers. Suitable glass fibers include those based on E, A, C, ECR, R, S, D, and NE glasses, as well as quartz. In some embodiments, the glass fibers have a diameter of about 2 to about 30 micrometers, specifically about 5 to about 25 micrometers, more specifically about 10 to about 15 micrometers. In some embodiments, the length of the glass fibers before compounding is about 2 to about 7 millimeters, specifically about 3 to about 5 millimeters. The glass fibers can, optionally, include a so-called adhesion promoter to improve its compatibility with the poly(phenylene ether) and the polystyrene. Adhesion promoters include chromium complexes, silanes, titanates, zirco-aluminates, propylene maleic anhydride copolymers, reactive cellulose esters and the like. Suitable glass fibers are commercially available from suppliers including, for example, Owens Corning, Nippon Electric Glass, PPG, and Johns Manville. When present, the glass fibers can be used in an amount of 5 to 100 parts by weight, or 5 to 80 parts by weight, or 5 to 75 parts by weight, or 5 to 50 parts by weight, or 10 to 40 parts by weight, or 20 to 30 parts by weight, based on 100 parts by weight total of the poly(phenylene ether), the polystyrene, and the hydrogenated block copolymer.

In a very specific embodiment of the injection molded article, the composition comprises 35 to 45 parts by weight of a poly(2,6-dimethyl-1,4-phenylene ether) having an intrinsic viscosity of 0.1 to 0.6 deciliter per gram, measured at 25° C. in chloroform, 43 to 53 parts by weight of an atactic homopolystyrene having a having a melt flow index of 1.5 to 3.5 grams per 10 minutes measured according to ISO 1133-4 (2011) at 200° C. and 5 kilogram load, and 5 to 15 parts by weight of a polystyrene-poly(ethylene-butylene)-polystyrene triblock copolymer having a weight average molecular weight of 200,000 to 400,000 grams/mole; wherein the parts by weight are based on 100 parts by weight total of the poly(phenylene ether), the polystyrene, and the hydrogenated block copolymer. In some embodiments, the composition comprises 5 to 75 parts by weight of glass fibers.

Another embodiment is a method of controlling microbial growth during transportation or storage of water, the method comprising transporting or storing the water in contact with a surface of a layer having a composition comprising 20 to 70 parts by weight of a poly(phenylene ether), 30 to 80 parts by weight of a polystyrene, and 1 to 15 parts by weight of a hydrogenated block copolymer of an alkenyl aromatic monomer and a conjugated diene; wherein the parts by weight are based on 100 parts by weight total of the poly(phenylene ether), the polystyrene, and the hydrogenated block copolymer. All of the variations described above for the inner layer of the lined pipe apply as well to the composition in the method of controlling microbial growth during transportation or storage of water. In some embodiments, the poly(phenylene ether) has a weight average molecular weight of 25,000 to 60,000 grams/mole. In some embodiments, the surface is characterized by surface roughness parameters Rₐ having a value of 3 to 15 nanometers, and R_{q} having a value of 7 to 25 nanometers.

In the method of controlling microbial growth, the composition can, optionally, include glass fibers. Suitable glass fibers include those based on E, A, C, ECR, R, S, D, and NE glasses, as well as quartz. In some embodiments, the glass fibers have a diameter of about 2 to about 30 micrometers, specifically about 5 to about 25 micrometers, more specifically about 10 to about 15 micrometers. In some embodiments, the length of the glass fibers before compounding is about 2 to about 7 millimeters, specifically about 3 to about 5 millimeters. The glass fibers can, optionally, include a so-called adhesion promoter to improve its compatibility with the poly(phenylene ether) and the polystyrene. Adhesion promoters include chromium complexes, silanes, titanates, zirco-aluminates, propylene maleic anhydride copolymers, reactive cellulose esters and the like. Suitable glass fibers are commercially available from suppliers including, for example, Owens Corning, Nippon Electric Glass, PPG, and Johns Manville. When present, the glass fibers can be used in an amount of 5 to 100 parts by weight, or 5 to 80 parts by weight, or 5 to 75 parts by weight, or 5 to 50 parts by weight, or 10 to 40 parts by weight, or 20 to 30 parts by weight, based on 100 parts by weight total of the poly(phenylene ether), the polystyrene, and the hydrogenated block copolymer.

In a very specific embodiment of the method of controlling microbial growth during transportation or storage of water, the method comprises transporting or storing the water in contact with a surface of a layer having a composition comprising 35 to 45 parts by weight of a poly(2,6-dimethyl-1,4-phenylene ether) having an intrinsic viscosity of 0.1 to 0.6 deciliter per gram, measured at 25° C. in chloroform, 43 to 53 parts by weight of an atactic homopolystyrene having a having a melt flow index of 1.5 to 3.5 grams per 10 minutes measured according to ISO 1133-4 (2011) at 200° C. and 5 kilogram load, and 5 to 15 parts by weight of a polystyrene-poly(ethylene-butylene)-polystyrene triblock copolymer having a weight average molecular weight of 200,000 to 400,000 grams/mole; wherein the parts by weight are based on 100 parts by weight total of the poly(phenylene ether), the polystyrene, and the hydrogenated block copolymer. In some embodiments, the composition comprises 5 to 75 parts by weight of glass fibers.

Another embodiment is a composition, comprising, 30 to 50 parts by weight of a poly(2,6-dimethyl-1,4-phenylene ether) having an intrinsic viscosity of 0.1 to 0.6 deciliter per gram measured by Ubbelohde viscometer at 25° C. in chloroform; 35 to 55 parts by weight of an atactic homopolystyrene having a having a melt flow index of 1 to 5 grams per 10 minutes measured according to ISO 1133-4 (2011) at 200° C. and 5 kilogram load; and 1 to 15 parts by weight of a hydrogenated block copolymer of an alkenyl aromatic monomer and a conjugated diene; wherein parts by weight are based on 100 parts by weight total of the poly(phenylene ether), the polystyrene, and the hydrogenated block copolymer; wherein the composition excludes rubber-modified polystyrene, excludes unhydrogenated block copolymers of styrene and butadiene, and comprises less than 1 part per million by weight of free butadiene, based on the total weight of the inner layer composition; and wherein the composition exhibits a Biomass Production Potential less than or equal to 500 picograms adenosine triphosphate per centimeter² determined according to NEN-EN 16421:2014 method 1. In some embodiments, the poly(phenylene ether) has a weight average molecular weight of 20,000 to 60,000 grams/mole. In some embodiments, the composition further comprises 5 to 50 parts by weight, or 15 to 45 parts by weight, of glass fibers. In some embodiments, the hydrogenated block copolymer is a food grade hydrogenated block copolymer, as described above. In some embodiments, the composition exhibits a Biomass Production Potential less than or equal to 300 picograms adenosine triphosphate per centimeter² determined according to NEN-EN 16421:2014 method 1.

The composition can, optionally, include glass fibers. Suitable glass fibers include those based on E, A, C, ECR, R, S, D, and NE glasses, as well as quartz. In some embodiments, the glass fibers have a diameter of about 2 to about 30 micrometers, specifically about 5 to about 25 micrometers, more specifically about 10 to about 15 micrometers. In some embodiments, the length of the glass fibers before compounding is about 2 to about 7 millimeters, specifically about 3 to about 5 millimeters. The glass fibers can, optionally, include a so-called adhesion promoter to improve its compatibility with the poly(phenylene ether) and the polystyrene. Adhesion promoters include chromium complexes, silanes, titanates, zirco-aluminates, propylene maleic anhydride copolymers, reactive cellulose esters and the like. Suitable glass fibers are commercially available from suppliers including, for example, Owens Corning, Nippon Electric Glass, PPG, and Johns Manville. When present, the glass fibers can be used in an amount of 5 to 100 parts by weight, or 5 to 80 parts by weight, or 5 to 75 parts by weight, or 10 to 50 parts by weight, or 10 to 40 parts by weight, or 20 to 30 parts by weight, based on 100 parts by weight total of the poly(phenylene ether), the polystyrene, and the hydrogenated block copolymer.

In a very specific embodiment of the composition, it comprises 37 to 47 parts by weight of the poly(phenylene ether), 42 to 52 parts by weight of the polystyrene, 5 to 15 parts by weight of the hydrogenated block copolymer, and 5 to 75 parts by weight of glass fibers.

The invention includes at least the following non-limiting embodiments.

Embodiment 1: A lined pipe for transporting water, comprising: an outer layer comprising an outer layer composition comprising, based on the total weight of the outer layer composition, 50 to 100 weight percent of a thermoplastic selected from the group consisting of crosslinked polyethylene, polypropylene, poly(1-butene), and poly(vinyl chloride), and 0 to 50 weight percent filler; and an inner layer comprising an inner layer composition comprising 20 to 70 parts by weight of a poly(phenylene ether), 30 to 80 parts by weight of a polystyrene, and 0 to 15 parts by weight of a hydrogenated block copolymer of an alkenyl aromatic monomer and a conjugated diene; wherein the parts by weight are based on 100 parts by weight total of the poly(phenylene ether), the polystyrene, and the hydrogenated block copolymer.

Embodiment 2: The lined pipe of embodiment 1, wherein the thermoplastic in the outer layer composition is polypropylene.

Embodiment 3: The lined pipe of embodiment 1 or 2, wherein the filler is selected from the group consisting of talc, clay, mica, calcium carbonate, and combinations thereof.

Embodiment 4: The lined pipe of any one of embodiments 1-3, wherein the poly(phenylene ether) is a poly(2,6-dimethyl-1,4-phenylene ether) having an intrinsic viscosity of 0.1 to 0.6 deciliter per gram measured by Ubbelohde viscometer at 25° C. in chloroform.

Embodiment 5: The lined pipe of any one of embodiments 1-4, wherein the polystyrene comprises an atactic homopolystyrene having a having a melt flow index of 1 to 5 grams per 10 minutes measured according to ISO 1133-4 (2011) at 200° C. and 5 kilogram load.

Embodiment 6: The lined pipe of any one of embodiments 1-5, wherein the inner layer composition comprises 1 to 15 parts by weight of the hydrogenated block copolymer; and wherein the hydrogenated block copolymer is a polystyrene-poly(ethylene-butylene)-polystyrene triblock copolymer having a polystyrene content of about 25 to 40 weight percent and a weight average molecular weight of about 200,000 to 400,000 grams/mole.

Embodiment 7: The lined pipe of any one of embodiments 1-6, wherein the inner layer comprises an inner surface characterized by surface roughness parameters Rₐ having a value of 3 to 15 nanometers, and R_{q} having a value of 7 to 25 nanometers.

Embodiment 8: The lined pipe of embodiment 1, wherein the outer layer composition comprises 95 to 100 weight percent polypropylene; wherein the poly(phenylene ether) comprises a poly(2,6-dimethyl-1,4-phenylene ether) having an intrinsic viscosity of 0.1 to 0.6 deciliter per gram, measured at 25° C. in chloroform; wherein the polystyrene comprises an atactic homopolystyrene having a having a melt flow index of 1.5 to 3.5 grams per 10 minutes measured according to ISO 1133-4 (2011) at 200° C. and 5 kilogram load; wherein the inner layer composition comprises 1 to 15 parts by weight of the hydrogenated block copolymer; and wherein the hydrogenated block copolymer is a polystyrene-poly(ethylene-butylene)-polystyrene triblock copolymer having a polystyrene content of about 25 to 40 weight percent and a weight average molecular weight of about 200,000 to 400,000 grams/mole; and wherein the inner layer composition comprises 35 to 45 parts by weight of the poly(phenylene ether), 43 to 53 parts by weight of the polystyrene, and 5 to 15 parts by weight of the hydrogenated block copolymer.

Embodiment 9: An injection molded article for water contact, the article comprising a composition comprising:30 to 50 parts by weight of a poly(2,6-dimethyl-1,4-phenylene ether) having an intrinsic viscosity of 0.1 to 0.6 deciliter per gram measured by Ubbelohde viscometer at 25° C. in chloroform; 35 to 55 parts by weight of an atactic homopolystyrene having a having a melt flow index of 1 to 5 grams per 10 minutes measured according to ISO 1133-4 (2011) at 200° C. and 5 kilogram load; and 1 to 15 parts by weight of a polystyrene-poly(ethylene-butylene)-polystyrene triblock copolymer; wherein parts by weight are based on 100 parts by weight total of the poly(phenylene ether), the polystyrene, and the hydrogenated block copolymer; wherein the composition excludes rubber-modified polystyrene, excludes unhydrogenated block copolymers of styrene and butadiene, and comprises less than 1 part per million by weight of free butadiene, based on the total weight of the inner layer composition; and wherein the composition exhibits a Biomass Production Potential less than or equal to 500 picograms adenosine triphosphate per centimeter² determined according to NEN-EN 16421:2014 method 1.

Embodiment 10: The injection molded article of embodiment 9, wherein the poly(2,6-dimethyl-1,4-phenylene ether) has a weight average molecular weight of 25,000 to 60,000 grams/mole.

Embodiment 11: The injection molded article of embodiment 10, wherein the composition further comprises 5 to 100 parts by weight of glass fibers.

Embodiment 12: A method of controlling microbial growth during transportation or storage of water, the method comprising transporting or storing the water in contact with a surface having a composition comprising 20 to 70 parts by weight of a poly(phenylene ether), 30 to 80 parts by weight of a polystyrene, and 1 to 15 parts by weight of a hydrogenated block copolymer of an alkenyl aromatic monomer and a conjugated diene; wherein the parts by weight are based on 100 parts by weight total of the poly(phenylene ether), the polystyrene, and the hydrogenated block copolymer.

Embodiment 13: The method of embodiment 12, wherein the composition further comprises 5 to 100 parts by weight of glass fibers.

Embodiment 14: The method of embodiment 12 or 13, wherein the poly(phenylene ether) has a weight average molecular weight of 20,000 to 60,000 grams/mole.

Embodiment 15: A composition, comprising, 30 to 50 parts by weight of a poly(2,6-dimethyl-1,4-phenylene ether) having an intrinsic viscosity of 0.1 to 0.6 deciliter per gram measured by Ubbelohde viscometer at 25° C. in chloroform; 35 to 55 parts by weight of an atactic homopolystyrene having a having a melt flow index of 1 to 5 grams per 10 minutes measured according to ISO 1133-4 (2011) at 200° C. and 5 kilogram load; and 1 to 15 parts by weight of a hydrogenated block copolymer of an alkenyl aromatic monomer and a conjugated diene; wherein parts by weight are based on 100 parts by weight total of the poly(phenylene ether), the polystyrene, and the hydrogenated block copolymer; wherein the composition excludes rubber-modified polystyrene, excludes unhydrogenated block copolymers of styrene and butadiene, and comprises less than 1 part per million by weight of free butadiene, based on the total weight of the inner layer composition; and wherein the composition exhibits a Biomass Production Potential less than or equal to 500 picograms adenosine triphosphate per centimeter² determined according to NEN-EN 16421:2014 method 1.

Embodiment 16: The composition of embodiment 15, wherein the poly(phenylene ether) has a weight average molecular weight of 20,000 to 60,000 grams/mole.

Embodiment 17: The composition of embodiment 15 or 16, further comprising 5 to 100 parts by weight of glass fibers.

Embodiment 18: The composition of any of embodiments 15-17, wherein the hydrogenated block copolymer is a food grade hydrogenated block copolymer.

Embodiment 19: The composition of any of embodiments 15-18, exhibiting a Biomass Production Potential less than or equal to 300 picograms adenosine triphosphate per centimeter² determined according to NEN-EN 16421:2014 method 1.

Embodiment 20: The composition of any of embodiments 15-19, comprising 37 to 47 parts by weight of the poly(phenylene ether), 42 to 52 parts by weight of the polystyrene, 5 to 15 parts by weight of the hydrogenated block copolymer, and 5 to 75 parts by weight of glass fibers.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### EXAMPLES 1-6

Components used to prepare the poly(phenylene ether) compositions are summarized in Table 1.

TABLE 1

| Component | Description |
|---|---|
| PPE | Poly(2,6-dimethyl-1,4-phenylene ether), CAS Reg. No. 24938-67-8, having an |
| | intrinsic viscosity of about 0.40 deciliter per gram as measured in chloroform at |
| | 25° C.; obtained as PPO ™ 640 Resin from SABIC Innovative Plastics. |
| PS | Atactic polystyrene, CAS Reg. No. 9003-53-6, having a melt flow index of 1.9 |
| | to 2.9 grams per 10 minutes measured at 200° C. and 5 kilogram load, obtained |
| | as EMPERA ™ 251N Resin from Ineos Styrenics International SA. |
| SEBS | Polystyrene-poly(ethylene-butylene)-polystyrene triblock copolymer, CAS Reg. |
| | No. 66070-58-4, having a polystyrene content of about 30 to 33 weight percent |
| | and a weight average molecular weight of about 253,000 to 310,000 grams/mole; |
| | obtained as KRATON ™ G1651 Resin from Kraton Polymers Nederland. |
| LDPE | Low density polyethylene, CAS Reg. No. 9002-88-4, having a density of 0.919 |
| | gram/milliliter at 25° C., a melt flow index of 22 grams/10 minutes measured at |
| | 190° C. and 2.16 kilogram load, milled to a particle diameter of about 1000 |
| | micrometers; obtained as LDPE 1922SF from SABIC Petrochemicals BV. |
| TBPP | Tris(2,4-di-tert-butylphenyl) phosphite, CAS Reg. No. 31570-04-4; obtained as |
| | IRGAFOS ™ 168 from BASF. |
| ZnO | Zinc oxide, CAS Reg. No. 1314-13-2; obtained as SACHTOLITH ™ HD-S from |
| | Sachtleben. |
| ZnS | Zinc sulfide, CAS Reg. No. 1314-98-3; obtained as HARZSIEGEL ™ CF from |
| | Norkem Norzinco GmbH. |
| GF | Chopped glass fiber having a thickness of about 14 micrometers and a silane |
| | surface treatment for compatibility with poly(phenylene ether); obtained as |
| | FC242A from Owens Corning, or CS 7993 from Lanxess. |

All components except for atactic polystyrene were dry-blended before compounding. Compositions were compounded on a 28 millimeter internal diameter twin-screw Werner & Pfleiderer extruder operating at a throughput of about 20 kilograms per hour and barrel temperatures of 40° C./210° C./260° C./280° C./280° C./270° C./280° C./280° C./290° C./290° C./300° C. from feed throat to die. All components were added at the feed throat. The extrudate was cooled in a water bath and pelletized, and the pellets were dried for 2 hours at 80° C. before use for injection molding.

Test articles for physical property testing were injection molded on an Engel 110T injection molding machine operating with barrel temperatures of 260 to 280° C. and a mold temperature of 80° C.

Compositions and properties are summarized in Table 2, where component amounts are expressed in parts by weight based on 100 parts by weight total of poly(phenylene ether), polystyrene, and hydrogenated block copolymer. Charpy impact strength values, expressed in units of kilojoules/meter² (kJ/m²), were determined at −30, 0, and 23° C. according to ISO 179-1 (2010) using Method ISO 179-1/1eA, an edgewise impact geometry, notched samples, bar dimensions of 80×10×4 millimeters, a pendulum energy of 4.2 joules, and five samples per composition. Flexural modulus and flexural strength values, each expressed in units of megapascals (MPa), and flexural strain at strength and stress at 3.5% strain values, each expressed in units of percent, were determined according to ISO 178-4 (2010) at 23° C. using bar dimensions of 80×10×4 millimeters, a support span of 64 millimeters, a test speed of 2 millimeters per minute, and five samples per composition. Heat deflection temperature (HDT) values, expressed in units of ° C., were determined according to ISO 75-1 and 75-2 (2004) using bar dimensions of 80×10×4 millimeters, a flatwise test direction, a loading fiber stress of 1.80 megapascals, and two samples per composition. Izod Notched Impact strength (INI) values, expressed in units of kilojoules/meter², were determined at −30, 0, and 23° C. according to ISO 180-1 (2006) using bar dimensions of 80×10×4 millimeters, notched samples, a pendulum energy of 5.5 joules, and five samples per composition. Multiaxial impact (MAI) puncture energy and energy at maximum force values, each expressed in units of joules, and deflection at break values, expressed in units of millimeters, were determined at 23° C. according to ISO 6603-2 (2000) using a test speed of 4.4 meters per second and five samples per composition. Values of tensile modulus, tensile stress at yield, and tensile stress at break, each expressed in units of megapascals, and values of tensile strain at yield and tensile strain at break, each expressed in units of percent, were determined at 23° C. according to ISO 527-1 and 527-2 (2012) using a test speed of 50 millimeters/minute and five samples per composition. Vicat softening temperature values, expressed in units of degrees centigrade, were determined according to ISO 306-4 (2004) using a 50 newton load and a test rate of 120° C. per hour and two samples per composition. Melt volume flow rate values, expressed in units of cubic-centimeters per 10 minutes, were determined according to ISO 1133-4 (2011) using pre-testing drying for 2 hours at 80° C., a temperature of 280° C., a 5 kilogram load, and a test time of 900 seconds.

TABLE 2

| | | | | | |
|---|---|---|---|---|---|
| Ex. 1 | Ex. 2 | Ex. 3 | Ex. 4 | Ex. 5 | Ex. 6 |

COMPOSITIONS

| | | | | | | |
|---|---|---|---|---|---|---|
| PS | 58.76 | 55.70 | 52.65 | 50.36 | 47.56 | 43.48 |
| PPE | 41.24 | 41.24 | 41.24 | 41.24 | 41.24 | 41.24 |
| SEBS | 0.00 | 3.05 | 6.11 | 8.40 | 11.20 | 15.27 |
| TBPP | 0.10 | 0.10 | 0.10 | 0.10 | 0.10 | 0.10 |
| ZnO | 0.10 | 0.10 | 0.10 | 0.10 | 0.10 | 0.10 |
| ZnS | 0.10 | 0.10 | 0.10 | 0.10 | 0.10 | 0.10 |
| LDPE | 1.53 | 1.53 | 1.53 | 1.53 | 1.53 | 1.53 |

PROPERTIES

| | | | | | | |
|---|---|---|---|---|---|---|
| Charpy impact, 23° C. (J) | 1.93 | 2.08 | 3.25 | 6.29 | 14.55 | 30.72 |
| Charpy impact, 0° C. (J) | 1.98 | 2.23 | 3.25 | 5.22 | 8.95 | 22.02 |
| Charpy impact, −30° C. (J) | 1.84 | 2.23 | 2.82 | 3.25 | 4.19 | 6.69 |
| Flex. modulus (MPa) | 2936 | 2838 | 2697 | 2520 | 2373 | 2171 |
| Flex. strength (MPa) | 115.93 | 108.85 | 101.71 | 93.46 | 86.95 | 78.79 |
| Flex. strain at strength (%) | 5.82 | 5.92 | 5.96 | 5.81 | 5.8 | 5.74 |
| Flex. stress at 3.5% strain (MPa) | 94.41 | 88.68 | 83.39 | 78.07 | 73.38 | 67.02 |
| HDT (° C.) | 117.8 | 118.3 | 118.15 | 118.25 | 118.7 | 119.15 |
| INI, 23° C. (kJ/m²) | 1.9 | 1.98 | 4.23 | 5.76 | 16.81 | 28.17 |
| INI, 0° C. (kJ/m²) | 1.87 | 1.94 | 4.30 | 4.42 | 7.83 | 21.24 |
| INI, −30° C. (kJ/m²) | 1.98 | 1.90 | 2.13 | 3.67 | 4.03 | 5.84 |
| MAI puncture energy, 23° C. (J) | 1.76 | 3.42 | 6.80 | 19.38 | 73.74 | 90.18 |
| MAI energy at max. force, | 1.68 | 3.00 | 6.30 | 15.16 | 49.86 | 61.4 |
| 23° C. (J) | | | | | | |
| MAI deflection at break, | 2.88 | 5.28 | 4.66 | 7.64 | 15.64 | 17.84 |
| 23° C. (mm) | | | | | | |
| MAI puncture energy, 0° C. (J) | 1.46 | 1.46 | 9.84 | 12.76 | 31.62 | 73.68 |
| MAI energy at max. force, | 1.38 | 1.30 | 8.58 | 11.98 | 28.92 | 55.48 |
| 0° C. (J) | | | | | | |
| MAI deflection at break, | 2.54 | 2.60 | 5.82 | 5.74 | 9.26 | 15.74 |
| 0° C. (mm) | | | | | | |
| MAI puncture energy, | 1.16 | 1.48 | 4.62 | 10.22 | 16.74 | 35.18 |
| −30° C. (J) | | | | | | |
| MAI energy at max. force, | 1.12 | 1.38 | 4.40 | 9.92 | 15.42 | 33.66 |
| −30° C. (J) | | | | | | |
| MAI deflection at break, | 2.26 | 2.78 | 4.30 | 5.22 | 6.86 | 9.64 |
| −30° C. (mm) | | | | | | |
| Tens. modulus (MPa) | 2968 | 2826.8 | 2724.4 | 2560.4 | 2409.8 | 2226.2 |
| Tens. stress at yield (MPa) | 80.28 | 78.69 | 74.76 | 67.73 | 62.11 | 56.24 |
| Tens. stress at break (MPa) | 79.28 | 76.98 | 66.46 | 49.76 | 45.67 | 44.47 |
| Tens. strain at yield (%) | 3.70 | 4.38 | 4.20 | 3.89 | 3.76 | 3.67 |
| Tens. strain at break (%) | 3.6 | 4.3 | 4.2 | 3.8 | 3.9 | — |
| Vicat temp. (° C.) | 135.8 | 136.5 | 137.6 | 137.3 | 137.6 | 137.0 |
| MVR (cm³/10 min) | 24.91 | 23.48 | 20.54 | 17.08 | 14.56 | 11.90 |

### EXAMPLES 7-11

These examples illustrate prophetic poly(phenylene ether) compositions comprising glass fibers. Compounding conditions are the same as for Example 1-6, except that glass fibers are added to the extruder via a downstream side feeder. In Table 3, component amounts are expressed in parts by weight based on 100 parts by weight total of poly(phenylene ether), polystyrene, and hydrogenated block copolymer.

TABLE 3

| | | | | |
|---|---|---|---|---|
| Ex. 7 | Ex. 8 | Ex. 9 | Ex. 10 | Ex. 11 |

COMPOSITIONS

| | | | | | |
|---|---|---|---|---|---|
| PS | 47.75 | 47.75 | 47.75 | 47.75 | 47.75 |
| PPE | 41.00 | 41.00 | 41.00 | 41.00 | 41.00 |
| SEBS | 11.25 | 11.25 | 11.25 | 11.25 | 11.25 |
| GF | 5.39 | 11.39 | 25.71 | 44.25 | 69.20 |
| TBPP | 0.11 | 0.11 | 0.13 | 0.15 | 0.17 |
| ZnO | 0.11 | 0.11 | 0.13 | 0.15 | 0.17 |
| LDPE | 1.62 | 1.71 | 1.93 | 2.21 | 2.60 |
| ZnS | 0.54 | 0.57 | 0.64 | 0.74 | 0.87 |

### Surface Roughness Measurements

These examples illustrate surface roughness characterization for as-extruded surfaces of high density polyethylene (HDPE), unplasticized poly(vinyl chloride) (PVC-u), and a poly(phenylene ether) composition (PPE).

The high density polyethylene was obtained as VESTOLEN A RELY 5924R Resin from SABIC. The poly(phenylene ether) composition was Example 5 from Table 2, above. The HDPE and PVC-u were extruded as a single layer having a thickness of about 32 millimeters. The poly(phenylene ether) composition was extruded as single layer having a thickness of 150 micrometers. The extrusion temperatures were 240° C. for high density polyethylene, 165° C. for poly(vinyl chloride), and 250° C. for the poly(phenylene ether) composition. A 4 by 4 micrometer area of each as-extruded surface was analyzed by atomic force microscopy. The resulting data were used to calculate R_{q} and Rₐ values according to the method of T. V. Vorburger and J. Raja, “Surface Finish Metrology Tutorial”, NISTIR 89-4088, June 1990, page 36, FIG. 3-22.

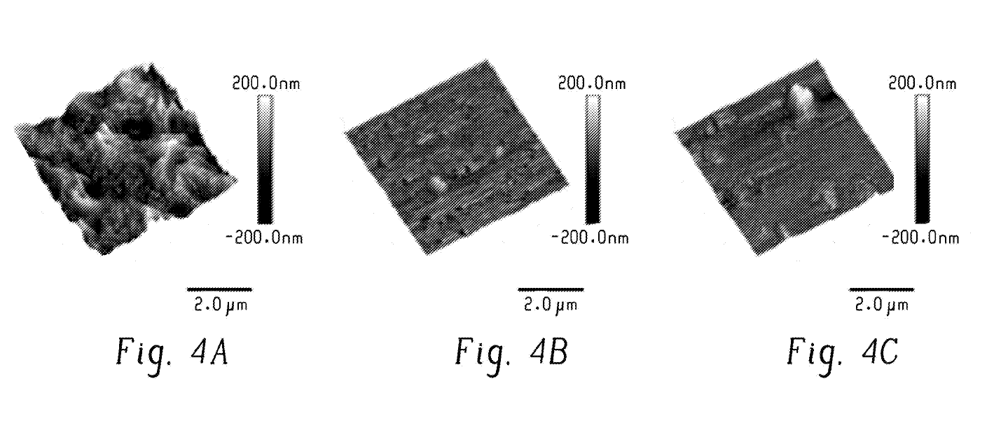

FIGS. 4A-4C show atomic force micrographs for as-extruded surfaces of high density polyethylene (4A), the poly(phenylene ether) composition (4B), and unplasticized poly(vinyl chloride) (4C). R_{q} and Rₐ values are presented in Table 4. The results show that the poly(phenylene ether) composition has the smoothest surface, with the unplasticized poly(vinyl chloride) surface being slightly rougher and the high density polyethylene surface being substantially rougher.

TABLE 4

| Material | R_{q} (nm) | Rₐ (nm) |
|---|---|---|
| HDPE | 69 | 54 |
| PVC-u | 22 | 11 |
| PPE | 14 | 7 |

### Coextrusion of Lined Pipe

Coextrusion is the extrusion of multiple layers of material simultaneously. Coextrusion utilizes two or more extruders to melt and deliver a steady volumetric throughput of different viscous plastics to a single extrusion head (die) from which the materials are extruded in the desired form. The layer thicknesses are controlled by the relative speeds and sizes of the individual extruders delivering the materials.

An outer layer consisting of polypropylene and having an annular cross-section is extruded at a melt temperature of about 235° C. The polypropylene has a melt flow of 0.3 grams/10 minutes measured at 230° C. and 2.16 kilogram load according to ASTM D 1238-13. It can be obtained as VESTOLEN P 9421 Resin from SABIC. An inner layer consisting of the Example 5 composition above and having an annular cross-section is coextruded at a melt temperature of about 245° C.

### EXAMPLE 12, COMPARATIVE EXAMPLES 1 AND 2

These examples illustrate that articles prepared from the present poly(phenylene ether) composition exhibit much better control of microbial growth in water, compared to corresponding articles prepared from poly(vinyl chloride). Testing was conducted according to NEN-EN 16421:2014, “Influence of materials on water for human consumption—Enhancement of microbial growth (EMG)”, method 1. In this test, borosilicate glass serves as a negative control (low microbial growth manifested as BPP<100 picograms ATP/cm²), plasticized poly(vinyl chloride) (PVC-p) as the positive control (high microbial growth manifested as BPP>10,000 picograms ATP/cm²), and the poly(phenylene ether) composition as the experimental sample.

Components used to form the poly(phenylene ether) composition are summarized in Table 5.

TABLE 5

| Component | Description |
|---|---|
| PPE | Poly(2,6-dimethyl-1,4-phenylene ether), CAS Reg. No. 24938-67-8, having an |
| | intrinsic viscosity of about 0.40 deciliter per gram as measured in chloroform at |
| | 25° C.; obtained as PPO ™ 640 Resin from SABIC Innovative Plastics. |
| PS | Atactic polystyrene, CAS Reg. No. 9003-53-6, having a melt flow index of 2 to |
| | 4 grams per 10 minutes measured at 200° C. and 5 kilogram load, obtained as |
| | STYROLUTION ™ 158N Resin from Ineos Styrenics International SA, or as |
| | POLYSTYRENE CRYSTAL 1160 from Total Petrochemicals USA Inc. |
| SEBS | Polystyrene-poly(ethylene-butylene)-polystyrene triblock copolymer, CAS Reg. |
| | No. 66070-58-4, having a polystyrene content of about 30 to 33 weight percent |
| | and a weight average molecular weight of about 253,000 to 310,000 grams/mole; |
| | obtained as KRATON ™ G1651 E Resin from Kraton Performance Polymers, or |
| | as CALPRENE ™ H6170 from Dynasol, Puteaux, France. |
| LDPE | Low density polyethylene, CAS Reg. No. 9002-88-4, having a density of 0.919 |
| | gram/milliliter at 25° C., a melt flow index of 22 grams/10 minutes measured at |
| | 190° C. and 2.16 kilogram load, milled to a particle diameter of about 1000 |
| | micrometers; obtained as LDPE 1922SF from SABIC Petrochemicals BV. |
| TBPP | Tris(2,4-di-tert-butylphenyl) phosphite, CAS Reg. No. 31570-04-4; obtained as |
| | IRGAFOS ™ 168 from BASF, as ALKANOX ™ 240 from Chemtura, or as |
| | EVERFOS ™-168 from Everspring Chemical Co. Ltd. |
| ZnO | Zinc oxide, CAS Reg. No. 1314-13-2; obtained as HARZSIEGEL ™ CF from |
| | Norkem Norzinco GmbH. |
| ZnS | Zinc sulfide, CAS Reg. No. 1314-98-3; obtained as SACHTOLITH ™ HD-S |
| | from Sachtleben. |

Compositions were compounded as described for Examples 1-6. The poly(phenylene ether) composition is summarized in Table 6, where component amounts are expressed in parts by weight per 100 parts by weight total of poly(phenylene ether) (PPE), polystyrene (PS), and hydrogenated block copolymer (SEBS).

TABLE 6

| Component | Ex. 12 |
|---|---|
| PS | 47.75 |
| PPE | 41.00 |
| SEBS | 11.25 |
| TBPP | 0.10 |
| ZnO | 0.10 |
| LDPE | 1.53 |
| ZnS | 0.51 |

One test piece of each of the three materials was placed in each of two test containers (that is, the test was run in duplicate). Each test piece had a total external surface area of about 150 centimeter². Each test containers was filled with appropriately amended drinking water (from Tull en 't Waal, The Netherlands) and inoculated with a mixture of naturally occurring microorganisms derived from a surface source of water.

The test pieces were incubated at 30° C. for a period of 16 weeks at a constant surface area to volume ratio of 0.16 centimeter⁻¹. This ratio was kept constant by adjusting the volume of the water in the test containers when a test piece was removed for biomass measurement. The test water was replaced once every seven days.

Formation of biomass on the test piece and in the water was determined with adenosine triphosphate (ATP) measurements after 8, 12, and 16 weeks of incubation. The ATP concentration of the total water volume was used in the calculation of Suspended Biomass (ATP picograms/milliliter). Values for duplicate samples were used to calculate an average and standard deviation.

The biomass adhered to the surface of the material was loosened with the aid of high-energy sonication in a small amount of water. The ATP concentration of this water was used in the calculation of Attached Biomass (picograms ATP/centimeter²). Values for duplicate samples were used to calculate an average and standard deviation.

Each test was validated by the satisfactory performance of the negative control (glass) and positive control (PVC-p) under equivalent conditions. The average ATP concentrations of the test pieces and test waters were used to calculate the Biomass Production value (BP) for each material (picograms ATP/centimeter²).

The Biomass Production Potential (BPP) was calculated as the average value of the BP values observed at 8, 12 and 16 weeks, minus the BP value for the negative control observed on the same days, and is expressed as picograms ATP/cm².

Test results are presented in Tables 7 and 8. The results show that biomass production in the presence of the poly(phenylene ether) composition was much lower than that in the presence of PVC and comparable to that in the presence of glass.

TABLE 7

| | | Suspended | | | Attached | | | Biomass | | |
|---|---|---|---|---|---|---|---|---|---|---|
| | | Biomass (SB) | | | Biomass (AB) | | | Production (BP) | | |
| | | (without | | | (without | | | (without | | |
| | | neg. control | | | neg. control | | | neg. control | | |
| | | correction) | | | correction) | | | correction) | | |
| | Exposure | pg | | | pg | | | pg | | |
| Material | Time | ATP/ | | | ATP/ | | | ATP/ | | |
| Description | (days) | mL | avg. | sd | cm² | avg. | sd | cm² | avg. | sd |
| Glass | 56 | 3.3 | 5.4 | 3.0 | 11 | 11 | 0.0 | 31 | 43 | 18 |
| | | 7.6 | | | 11 | | | 56 | | |
| PVC-p | 56 | 252 | 233 | 27 | 16893 | 28869 | 16809 | 18350 | 30132 | 16662 |
| | | 214 | | | 40754 | | | 41914 | | |
| Ex. 12 | 56 | 5.6 | 7.0 | 1.9 | 71 | 52 | 28 | 103 | 91 | 17 |
| | | 8.3 | | | 32 | | | 80 | | |
| Glass | 84 | 3.5 | 5.3 | 2.6 | 13 | 14 | 2.0 | 34 | 47 | 18 |
| | | 7.2 | | | 16 | | | 59 | | |
| PVC-p | 84 | 253 | 479 | 307 | 17486 | 22972 | 7759 | 18869 | 25486 | 9358 |
| | | 687 | | | 28459 | | | 32103 | | |
| Ex. 12 | 84 | 6.2 | 7.2 | 1.3 | 53 | 49 | 6 | 88 | 90 | 2 |
| | | 8.1 | | | 45 | | | 91 | | |
| Glass | 112 | 4.6 | 7.1 | 3.5 | 23 | 24 | 2 | 51 | 67 | 23 |
| | | 9.5 | | | 25 | | | 83 | | |
| PVC-p | 112 | 215 | 440 | 319 | 27679 | 29530 | 2617 | 28847 | 31859 | 4259 |
| | | 666 | | | 31380 | | | 34871 | | |
| Ex. 12 | 112 | 5.6 | 5.8 | 0.2 | 69 | 62 | 9 | 101 | 96 | 8 |
| | | 6.0 | | | 56 | | | 90 | | |

TABLE 8

| | | | | | | Biomass | |
|---|---|---|---|---|---|---|---|
| | | Suspended | | Attached | | Production | |
| | | Biomass | | Biomass | | Potential | |
| | Ex- | (SB) | | (AB) | | (BPP) | |
| Material | posure | pg | | pg | | pg | |
| De- | Time | ATP/ | | ATP/ | | ATP/ | |
| scription | (days) | mL | sd | cm² | sd | cm² | sd |
| Glass | 56 | 5.4 | 3.0 | 11 | 0.0 | 52 | 2 |
| (neg. | 84 | 5.3 | 2.6 | 14 | 2.0 | | |
| control) | 112 | 7.1 | 3.5 | 24 | 2.0 | | |
| | average | 5.9 | 3.1 | 16 | 2.0 | | |
| PVC-p | 56 | 233 | 27 | 28869 | 16809 | 29159 | 11304 |
| (pos. | 84 | 470 | 307 | 22972 | 7759 | | |
| control) | 112 | 440 | 319 | 29530 | 2617 | | |
| | average | 381 | 256 | 27124 | 10795 | | |
| Ex. 12 | 56 | 1.5 | 3.6 | 41 | 28 | 40 | 22 |
| | 84 | 1.8 | 2.9 | 34 | 6 | | |
| | 112 | −1.3 | 3.5 | 38 | 9 | | |
| | average | 0.7 | 3.3 | 38 | 17 | | |

1. A lined pipe for transporting water, comprising:
an outer layer comprising an outer layer composition comprising, based on the total weight of the outer layer composition,
50 to 100 weight percent of a thermoplastic selected from the group consisting of crosslinked polyethylene, polypropylene, poly(1-butene), and poly(vinyl chloride), and
0 to 50 weight percent filler; and
an inner layer comprising an inner layer composition comprising
20 to 70 parts by weight of a poly(phenylene ether),
30 to 80 parts by weight of a polystyrene, and
0 to 15 parts by weight of a hydrogenated block copolymer of an alkenyl aromatic monomer and a conjugated diene;
wherein the parts by weight are based on 100 parts by weight total of the poly(phenylene ether), the polystyrene, and the hydrogenated block copolymer.

2. The lined pipe of claim 1, wherein the thermoplastic in the outer layer composition is polypropylene.

3. The lined pipe of claim 1, wherein the filler is selected from the group consisting of talc, clay, mica, calcium carbonate, and combinations thereof.

4. The lined pipe of claim 1, wherein the poly(phenylene ether) is a poly(2,6-dimethyl-1,4-phenylene ether) having an intrinsic viscosity of 0.1 to 0.6 deciliter per gram measured by Ubbelohde viscometer at 25° C. in chloroform.

5. The lined pipe of claim 1, wherein the polystyrene comprises an atactic homopolystyrene having a having a melt flow index of 1 to 5 grams per 10 minutes measured according to ISO 1133-4 (2011) at 200° C. and 5 kilogram load.

6. The lined pipe of claim 1, wherein the inner layer composition comprises 1 to 15 parts by weight of the hydrogenated block copolymer; and wherein the hydrogenated block copolymer is a polystyrene-poly(ethylene-butylene)-polystyrene triblock copolymer having a polystyrene content of 25 to 40 weight percent and a weight average molecular weight of 200,000 to 400,000 grams/mole.

7. The lined pipe of claim 1, wherein the inner layer comprises an inner surface characterized by surface roughness parameters Rₐ having a value of 3 to 15 nanometers, and R_{q} having a value of 7 to 25 nanometers.

8. The lined pipe of claim 1,
wherein the outer layer composition comprises 95 to 100 weight percent polypropylene;
wherein the poly(phenylene ether) comprises a poly(2,6-dimethyl-1,4-phenylene ether) having an intrinsic viscosity of 0.1 to 0.6 deciliter per gram, measured at 25° C. in chloroform;
wherein the polystyrene comprises an atactic homopolystyrene having a having a melt flow index of 1.5 to 3.5 grams per 10 minutes measured according to ISO 1133-4 (2011) at 200° C. and 5 kilogram load;
wherein the inner layer composition comprises 1 to 15 parts by weight of the hydrogenated block copolymer; and wherein the hydrogenated block copolymer is a polystyrene-poly(ethylene-butylene)-polystyrene triblock copolymer having a polystyrene content of 25 to 40 weight percent and a weight average molecular weight of 200,000 to 400,000 grams/mole; and
wherein the inner layer composition comprises
35 to 45 parts by weight of the poly(phenylene ether),
43 to 53 parts by weight of the polystyrene, and
5 to 15 parts by weight of the hydrogenated block copolymer.

9. An injection molded article for water contact, the article comprising a composition comprising:
30 to 50 parts by weight of a poly(2,6-dimethyl-1,4-phenylene ether) having an intrinsic viscosity of 0.1 to 0.6 deciliter per gram measured by Ubbelohde viscometer at 25° C. in chloroform;
35 to 55 parts by weight of an atactic homopolystyrene having a having a melt flow index of 1 to 5 grams per 10 minutes measured according to ISO 1133-4 (2011) at 200° C. and 5 kilogram load; and
1 to 15 parts by weight of a polystyrene-poly(ethylene-butylene)-polystyrene triblock copolymer;
wherein parts by weight are based on 100 parts by weight total of the poly(phenylene ether), the polystyrene, and the hydrogenated block copolymer;
wherein the composition excludes rubber-modified polystyrene, excludes unhydrogenated block copolymers of styrene and butadiene, and comprises less than 1 part per million by weight of free butadiene, based on the total weight of the inner layer composition; and
wherein the composition exhibits a Biomass Production Potential less than or equal to 500 picograms adenosine triphosphate per centimeter determined according to NEN-EN 16421:2014 method 1.

10. The injection molded article of claim 9, wherein the poly(2,6-dimethyl-1,4-phenylene ether) has a weight average molecular weight of 25,000 to 60,000 grams/mole.

11. The injection molded article of claim 9, wherein the composition further comprises 5 to 100 parts by weight of glass fibers.

12. A method of controlling microbial growth during transportation or storage of water, the method comprising transporting or storing the water in contact with a surface having a composition comprising
20 to 70 parts by weight of a poly(phenylene ether),
30 to 80 parts by weight of a polystyrene, and
1 to 15 parts by weight of a hydrogenated block copolymer of an alkenyl aromatic monomer and a conjugated diene;
wherein the parts by weight are based on 100 parts by weight total of the poly(phenylene ether), the polystyrene, and the hydrogenated block copolymer.

13. The method of claim 12, wherein the composition further comprises 5 to 100 parts by weight of glass fibers.

14. The method of claim 12, wherein the poly(phenylene ether) has a weight average molecular weight of 20,000 to 60,000 grams/mole.

15. A composition, comprising,
30 to 50 parts by weight of a poly(2,6-dimethyl-1,4-phenylene ether) having an intrinsic viscosity of 0.1 to 0.6 deciliter per gram measured by Ubbelohde viscometer at 25° C. in chloroform;
35 to 55 parts by weight of an atactic homopolystyrene having a having a melt flow index of 1 to 5 grams per 10 minutes measured according to ISO 1133-4 (2011) at 200° C. and 5 kilogram load; and
1 to 15 parts by weight of a hydrogenated block copolymer of an alkenyl aromatic monomer and a conjugated diene;
wherein parts by weight are based on 100 parts by weight total of the poly(phenylene ether), the polystyrene, and the hydrogenated block copolymer;
wherein the composition excludes rubber-modified polystyrene, excludes unhydrogenated block copolymers of styrene and butadiene, and comprises less than 1 part per million by weight of free butadiene, based on the total weight of the inner layer composition; and
wherein the composition exhibits a Biomass Production Potential less than or equal to 500 picograms adenosine triphosphate per centimeter² determined according to NEN-EN 16421:2014 method 1.

16. The composition of claim 15, wherein the poly(phenylene ether) has a weight average molecular weight of 20,000 to 60,000 grams/mole.

17. The composition of claim 15, further comprising 5 to 100 parts by weight of glass fibers.

18. The composition of claim 15, wherein the hydrogenated block copolymer is a food grade hydrogenated block copolymer.

19. The composition of claim 15, exhibiting a Biomass Production Potential less than or equal to 300 picograms adenosine triphosphate per centimeter² determined according to NEN-EN 16421:2014 method 1.

20. The composition of claim 15, comprising
37 to 47 parts by weight of the poly(phenylene ether),
42 to 52 parts by weight of the polystyrene,
5 to 15 parts by weight of the hydrogenated block copolymer, and
5 to 75 parts by weight of glass fibers.
